(19) United States
(12) Patent Application Publication
(10) Pub. No.: US 2015/0086746 A1
(43) Pub. Date: Mar. 26, 2015

(54) VINYL ESTER/ETHYLENE COPOLYMER DISPERSIONS PREPARED BY CONTINUOUS TUBULAR EMULSION POLYMERIZATION FOR COATING CARPET PRODUCTS

(71) Applicant: CELANESE EMULSIONS GmbH, Sulzbach (DE)

(72) Inventors: Lizandra B.R. de Castro, Sao Paulo (BR); David Adams, Bad Soden (DE)

(73) Assignee: CELANESE EMULSIONS GMBH, Sulzbach (DE)

(21) Appl. No.: 14/399,742

(22) PCT Filed: May 15, 2013
(86) PCT No.: PCT/IB2013/001471

§ 371 Date: Nov. 7, 2014

Related U.S. Application Data
(60) Provisional application No. 61/648,778, filed on May 18, 2012.

(51) Int. Cl. C09D 131/04; D06N 7/00

(52) U.S. Cl. CPC C09D 131/04; D06N 7/0063
USPC 428/96; 524/563

(57) ABSTRACT

Disclosed are aqueous compositions suitable for use as binders or adhesives in carpet products. Such compositions, prior to being applied to carpet substrates and cured, comprise vinyl ester/ethylene copolymer dispersions, along with other optional comonomers. The compositions are made by a continuous emulsion polymerisation that utilises a continuous loop reactor with a secondary line section. Carpet products which utilise such coating compositions to provide binder and/or adhesive layer within the carpet are also disclosed.

### FIELD

The present invention relates to aqueous dispersions of vinyl ester/ethylene copolymers formed from a continuous emulsion polymerization process using a continuous tubular reactor and to their use in carpet coating compositions.

### BACKGROUND

Most conventional carpets comprise a primary backing with yarn tufts in the form of cut or uncut loops extending upwardly from this backing to form a pile surface. For tufted carpets, the yarn is inserted into a primary backing (frequently a woven or nonwoven substrate) by tufting needles and a pre-coat (i.e., a binder) is applied thereto. In the case of non-tufted or bonded pile carpets, the fibers are embedded and actually held in place by the binder composition.

Many residential and commercial carpets are also manufactured with a woven scrim (typically made from polypropylene) attached to the back of the carpet to provide dimensional stability to the carpet. These are dual layer products, where two coating layers (precoat for tuft anchorage and adhesive for scrim fixation) are added wet, and the scrim is added afterwards. After optional fixation of the scrim, the carpet is cured at 130 to 200° C. for a certain time.

For both the pre-coat and the adhesive layer, the physical properties of the binder are important to their successful utilization as carpet coatings. In this regard, there are a number of important requirements which must be met by such coatings. The coating must be capable of being applied to the carpet and dried using the processes and equipment conventionally employed in the carpet industry for latex, e.g. emulsion, coating. The binder composition must provide excellent adhesion to the pile fibers to secure them firmly in the backing. Further, coatings used as adhesives must also be able to secure substrates to the carpet secondary backing, thereby enabling the preparation of material for use in wall-to-wall carpeting. The coating also must have low smoke density values and high flame retardant properties and must accept fillers such as calcium carbonate, clay, aluminum trihydrate, barite, and feldspar. Furthermore, the coating must maintain sufficient softness and flexibility, even with high filler loading or at low temperature, to enable the carpet, if prepared in continuous form, to be easily rolled and unrolled during installation. The softness and flexibility properties will vary depending on the style of carpet but, in all cases, it is important that the carpet tile will lie flat and not exhibit a tendency to curl or dome.

The binders in coating and adhesive compositions for carpet materials are frequently emulsion polymers, i.e., latex dispersions, such as styrene-based emulsion copolymers like styrene-butadiene latex (SBL) materials or such as acrylic polymer latex dispersions. Copolymers of vinyl esters (such as vinyl acetate and vinyl versatate) and vinyl ester/ethylene can also be used and can frequently have cost and performance advantages such as flame retardancy over styrene-based coatings and adhesives such as SBL. For example, vinyl ester copolymers can be used to provide carpet products which are desirably low in VOC (volatile organic compound) content and which do not contain potentially toxic materials such as 4-phenyl cyclohexene (4-PCH) and related compounds which can be found in styrene-butadiene-based polymer dispersions. Vinyl ester copolymers form carpet coating and adhesive layers which are also advantageously resistant to degradation by visible light and/or ultraviolet (UV) radiation.

Carpet coating compositions based on vinyl ester/ethylene, e.g., vinyl acetate/ethylene (VAE), copolymers and also containing a variety of filler materials are disclosed, for example, in U.S. Pat. Nos. 5,026,765; 5,849,389; and 6,359,076. In U.S. Pat. No. 4,735,986, there are disclosed carpet backing adhesive compositions comprising vinyl acetate/ethylene copolymer emulsions and relatively large amounts of fillers. The use of fillers can reduce the overall cost of the coating compositions. The '986 patent reports that VAE copolymer emulsions which have been stabilized with both nonionic surfactants and various forms of hydrolyzed polyvinyl alcohol can be used to produce carpet adhesive compositions which have acceptable viscosity characteristics and sufficient compatibility between the VAE copolymer and filler material.

Traditionally vinyl ester/ethylene dispersion polymers are made in stirred tank reactors. In this situation, the throughput is limited by the reactor volume. The making of large production amounts of polymer requires a relatively large space and a high cooling capacity. Furthermore, significant time is required for discharging and preparing the stirred reactor for the next batch, increasing the total cycle time.

In addition to a vinyl ester and ethylene, carpet coating compositions typically include a functional monomer in their preparation. Such functional monomers are added to improve the properties of the final copolymer dispersion. However, utilizing such monomers introduces an additional cost as well as an additional step to the process.

Another component typically included in such compositions that can add additional cost is an ionic surfactant. Such surfactants are added in order to stabilize the emulsions.

Notwithstanding the availability of carpet coating compositions containing both VAE copolymer binding agents and various types of filler materials, it would be advantageous to provide additional vinyl ester/ethylene-based carpet coating compositions which use less functional monomer and ionic surfactant or do not require the addition of functional monomer or ionic surfactant. It would also be beneficial to provide vinyl ester/ethylene-based carpet coating compositions capable of containing relatively high amounts of filler, i.e., a high filler load. Additionally, it would be advantageous if the vinyl ester/ethylene carpet coating compositions could be made more quickly, efficiently, and/or with more predictable, or less variance in, properties. By utilizing a continuous closed loop polymerization process as described hereinafter, such desirable carpet coating compositions and carpet products can be realized.

### SUMMARY

In one aspect, the present development is directed to carpet coating composition comprising an aqueous dispersion of a copolymer comprising polymerized comonomers vinyl acetate and ethylene, where the dispersion is prepared by a continuous emulsion polymerization in a reactor comprising a closed loop section and a secondary line section. In other embodiments, the emulsion polymerization reactor comprises a first section with a circulation loop with one or more inlets for raw material, a pump for circulating a reactor charge within the circulation loop, and a secondary line section not forming a closed loop connected to a discharge of the loop section.

Another aspect of the invention involves a carpet comprising a carpet backing or substrate, carpet fibers, and a carpet coating composition which comprises an aqueous dispersion of a copolymer comprising polymerized monomers vinyl acetate and ethylene, where the dispersion is prepared by a continuous emulsion polymerization in a loop reactor.

In yet another aspect, the present development is directed to carpet products comprising at least one flexible substrate and at least one binder coating layer associated with the at least one flexible substrate. Such a binder coating layer is formed from an aqueous coating composition of the type hereinbefore described with the binder coating serving to affix carpet fibers to a carpet backing substrate. In another embodiment, such carpet products also contain an adhesive layer which is likewise formed from an aqueous coating composition of the type hereinbefore described. Such an adhesive layer serves to affix a second substrate or scrim as an element of the carpet product.

### BRIEF DESCRIPTION OF THE DRAWINGS

FIG. 1 is a schematic diagram of a continuous closed loop polymerization process according to one example of the invention.

### DETAILED DESCRIPTION

The carpet coating compositions described herein comprise aqueous dispersions of vinyl ester/ethylene copolymers polymerized in a continuous loop process. The vinyl ester/ethylene copolymer in the copolymer dispersion comprises main co-monomers which include a vinyl ester, such as vinyl acetate, which is copolymerized with ethylene and optionally copolymerized also with one or more additional different non-functional main comonomer(s). Such additional non-functional main co-monomer(s) can be vinyl esters of C₁-C₁₈ mono-carboxylic acids or C₁-C₁₈ esters of ethylenically unsaturated mono-carboxylic acids or C₁-C₁₈ diesters of ethylenically unsaturated di-carboxylic acids.

The compositions can be used as aqueous coating compositions which contain vinyl ester/ethylene copolymers dispersed as the coating- or binder-forming component thereof, optionally together with a selected type of particulate filler material. The components and preparation of such aqueous coating compositions, the copolymer dispersion and filler components thereof and carpet products having at least one binder coating and/or adhesive layer formed from these compositions are all described in detail as follows:

### Monomers

The primary main monomer used in the preparation of the copolymer dispersion used in the present carpet coating composition is vinyl ester. In a preferred embodiment, this vinyl ester is vinyl acetate. The vinyl ester is generally present in the copolymer of the dispersion in amounts of from about 40% to about 95% by weight, more preferably from about 75% to 90% by weight, based on the total main co-monomers in the copolymer. The second main co-monomer for incorporation into the copolymer of the dispersion is ethylene. The ethylene will generally comprise from about 5% to about 25% by weight, preferably 8% to about 25% by weight, most preferably from about 10% to about 15% by weight, based on the total main co-monomers in the copolymer.

The vinyl acetate/ethylene copolymer of the copolymer dispersion can optionally comprise one or more additional non-functional main co-monomers besides vinyl acetate and ethylene. One type of such optional non-functional co-monomer comprises other vinyl ester co-monomers. Examples thereof are vinyl esters of monocarboxylic acids having one to eighteen carbon atoms (except vinyl acetate), e.g. vinyl formate, vinyl propionate, vinyl butyrate, vinyl isobutyrate, vinyl benzoate, vinyl-2-ethyl-hexanoate, vinyl esters of an [alpha]-branched carboxylic acid having 5 to 11 carbon atoms in the acid moiety, e.g., Versatic™ acids, and the vinyl esters of pivalic, 2-ethylhexanoic, lauric, palmitic, myristic, and stearic acid. Vinyl esters of Versatic™0 acids, more particularly VeoVa™ 9, VeoVa™ 10, and VeoVa™ 11, are preferred.

Another type of optional main non-functional co-monomer which can be incorporated into the vinyl acetate/ethylene copolymer comprises esters of ethylenically unsaturated mono-carboxylic acids or diesters of ethylenically unsaturated di-carboxylic acids. Particularly advantageous co-monomers of this type are the esters of acids having one to eighteen carbon atoms. Examples of such non-functional, main co-monomers include methyl methacrylate or acrylate, butyl methacrylate or acrylate, 2-ethylhexyl methacrylate or acrylate, dibutyl maleate and/or dioctyl maleate.

Combinations of two or more of the forgoing optional non-functional main co-monomer types can be co-polymerized into the vinyl acetate/ethylene copolymer. If present, such non-functional main co-monomers can comprise up to about 40 wt % based on the total main co-monomers in the copolymer. More preferably, such non-functional main co-monomers can comprise from about 5 wt % to about 20 wt %, based on the total main co-monomers in the vinyl acetate/ethylene copolymer. However, some preferred embodiments of the present invention do not contain said optional non-functional comonomer.

The vinyl acetate/ethylene emulsion copolymer used in the carpet products herein can also optionally contain relatively minor amounts of other types of co-monomers besides vinyl acetate, ethylene or other main co-monomer types. Such other optional co-monomers will frequently be those which contain one or more functional groups and can serve to provide or facilitate cross-linking between copolymer chains within the copolymer dispersion-containing aqueous composition, or upon the drying or curing of films and coatings formed from such compositions. However, some preferred embodiments of the present invention do not contain cross-linker.

Such optional functional co-monomers can include ethylenically unsaturated acids, e.g. mono- or di-carboxylic acids, sulfonic acids or phosphonic acids. In place of the free acids, it is also possible to use their salts, preferably alkali metal salts or ammonium salts. Examples of optional functional co-monomers of this type include acrylic acid, methacrylic acid, crotonic acid, maleic acid, fumaric acid, itaconic acid, vinylsulfonic acid, vinylphosphonic acid, styrenesulfonic acid, monoesters of maleic and/or fumaric acid, and of itaconic acid, with monohydric aliphatic saturated alcohols of chain length C₁-C₁₈, and also their alkali metal salts and ammonium salts, or (meth)acrylic esters of sulfoalkanols, an example being sodium 2-sulfoethyl methacrylate. However, it is an aspect of this invention to produce vinyl acetate/ethylene emulsions that do not require acid type functional monomers.

Other types of suitable optional functional co-monomers include ethylenically unsaturated co-monomers with at least one amide-, epoxy-, hydroxyl, trialkoxysilane- or carbonyl group. Particularly suitable are ethylenically unsaturated epoxide compounds, such as glycidyl methacrylate or glycidyl acrylate. Also suitable are hydroxyl compounds including methacrylic acid and acrylic acid C₁-C₉ hydroxyalkyl esters, such as n-hydroxyethyl, n-hydroxypropyl or n-hydroxybutyl acrylate and methacrylate. Other suitable functional co-monomers include compounds such as diacetone acrylamide and acetylacetoxyethyl acrylate and methacrylate; and amides of ethylenically unsaturated carboxylic acids, such as acrylamide or meth acrylamide. However, it is an aspect of the present invention to minimize or eliminate the use of functional co-monomer.

As noted, the emulsion copolymer used herein can optionally contain trialkoxysilane functional co-monomers. Alternatively, the emulsion copolymers used herein can be substantially free of silane-based co-monomers.

One type of functional co-monomer which should not be incorporated into the vinyl acetate/ethylene copolymers used herein comprises any co-monomer which contains cross-linkable moieties that generate formaldehyde upon formation of the coating or adhesive layer from compositions containing such copolymers. Thus the vinyl acetate/ethylene copolymer in the copolymer dispersion is preferably substantially free of such co-monomers, which include, for example, common cross-linkers like N-methylolacrylamide (NMA) or even low formaldehyde versions of N-methylolacrylamide such as NMA-LF.

Optional functional co-monomers can be incorporated into the vinyl acetate/ethylene emulsion copolymers used herein in amount of up to about 5 wt %, based on total main co-monomers in the copolymer. More preferably, optional functional co-monomers can comprise from about 0.5 wt % to about 2 wt %, based on total main co-monomers in the copolymer. However, in preferred embodiments, the copolymers of the present invention contain no functional co-monomer.

The emulsion copolymer can be formed using emulsion polymerization techniques described more fully hereinafter. Within the copolymer dispersion, the copolymer will generally be present in the form of particles ranging in weight average particle size, d_{w}, of from about 50 nm to about 800 nm, such as from about 200 nm to about 500 nm, as measured by laser aerosol sprectroscopy.

Depending upon co-monomer type, solubility and the monomer feeding techniques employed, the vinyl ester-ethylene based copolymer can be either homogeneous or heterogeneous in monomeric configuration and make-up. Homogeneous copolymers have a single discreet glass transition temperature, T_{g}, as determined by differential scanning calorimetry techniques. Heterogeneous copolymers have two or more discreet glass transition temperatures and may exhibit core shell particle morphologies. Whether homogeneous or heterogeneous, the vinyl ester-based copolymer used herein typically have glass transition temperatures, T_{g}, which range between about 0° C. and 25° C., more preferably between about 5° C. and 15° C. As is known, the T_{g} of the polymer can be controlled, for example, by adjusting the ethylene content, i.e., generally the more ethylene present in the copolymer relative to other co-monomers, the lower the T_{g}.

### Stabilizers

Both during polymerization and thereafter, the copolymer used to prepare the aqueous carpet coating composition described herein is stabilized in the form of an aqueous copolymer dispersion or latex. The copolymer dispersion therefore will be prepared in the presence of and will contain a stabilization system which generally comprises emulsifiers, in particular nonionic emulsifiers and/or anionic emulsifiers. Mixtures of nonionic and anionic emulsifiers can also be employed. However, it is an aspect of this invention to reduce or eliminate the need for ionic emulsifiers.

The amount of emulsifier employed will generally be at least 0.5 wt %, based on the total quantity of main co-monomers in the copolymer dispersion. Generally emulsifiers can be used in amounts up to about 8 wt %, based on the total quantity of main co-monomers in the copolymer dispersion. The weight ratio of emulsifiers nonionic to anionic may fluctuate within wide ranges, between 1:1 and 50:1 for example.

Emulsifiers employed herein may include nonionic emulsifiers having alkylene oxide groups and/or anionic emulsifiers having sulfate, sulfonate, phosphate and/or phosphonate groups. Such emulsifiers, if desired, can be used together with molecularly or dispersely water-soluble polymers, preferably together with polyvinyl alcohol and/or block copolymers of polypropylene glycol and polyethylene glycol. Preferably also the emulsifiers used contain no alkylphenolethoxylates (APEO).

Examples of suitable nonionic emulsifiers include acyl, alkyl, oleyl, and alkylaryl ethoxylates. These products are commercially available, for example, under the name Genapol®, Lutensol® or Emulan®. They include, for example, ethoxylated mono-, di-, and tri-alkylphenols (EO degree: 3 to 50, alkyl substituent radical: C₄ to C₁₂) and also ethoxylated fatty alcohols (EO degree: 3 to 80; alkyl radical: C₈ to C₃₆), especially C₁₂-C₁₄ fatty alcohol (3-40) ethoxylates, C₁₃-C₁₅ oxo-process alcohol (3-40) ethoxylates, C₁₆-C₁₈ fatty alcohol (11-80) ethoxylates, C₁₀ oxo-process alcohol (3-40) ethoxylates, C₁₃ oxo-process alcohol (3-40) ethoxylates, polyoxyethylenesorbitan monooleate with 20 ethylene oxide groups, copolymers of ethylene oxide and propylene oxide having a minimum ethylene oxide content of 10% by weight, the polyethylene oxide (4-40) ethers of oleyl alcohol, and the polyethene oxide (4-40) ethers of nonylphenol. Particularly suitable are the polyethylene oxide (4-40) ethers of fatty alcohols, more particularly of oleyl alcohol, stearyl alcohol or C₁₁ alkyl alcohols.

The amount of nonionic emulsifiers used in preparing the copolymer dispersions herein is typically about 1% to about 8% by weight, preferably about 1% to about 5% by weight, more preferably about 1% to about 4% by weight, based on the total main monomer quantity. Mixtures of nonionic emulsifiers can also be employed.

Examples of suitable anionic emulsifiers include sodium, potassium, and ammonium salts of linear and branched aliphatic carboxylic acids of chain length C₁₂-C₂ₒ, sodium hydroxyoctadecanesulfonate, sodium, potassium, and ammonium salts of hydroxy fatty acids of chain length C₁₂-C₂₀ and their sulfonation and/or sulfation and/or acetylation products, alkyl sulfates, including those in the form of triethanolamine salts, alkyl(C ₁₀⁻C₂₀) sulfonates, alkyl(C₁₀-C₂₀) arylsulfonates, dimethyl-dialkyl (C₈-C₁₈) ammonium chloride, and their sulfonation products, lignosulfonic acid and its calcium, magnesium, sodium, and ammonium salts, resin acids, hydrogenated and dehydrogenated resin acids, and their alkali metal salts, dodecylated sodium diphenyl ether disulfonate, sodium lauryl sulfate, sulfated alkyl or aryl ethoxylate with EO degree between 1 and 10, for example ethoxylated sodium lauryl ether sulfate (EO degree 3) or a salt of a bisester, preferably of a bis-C₄-C₁₈ alkyl ester, of a sulfonated dicarboxylic acid having 4 to 8 carbon atoms, or a mixture of these salts, preferably sulfonated salts of esters of succinic acid, more preferably salts, such as alkali metal salts, of bis-C₄-C₁₈ alkyl esters of sulfonated succinic acid, or phosphates of polyethoxylated alkanols or alkylphenols.

The amount of anionic emulsifiers used can typically range from 0 to about 3.0% by weight, preferably from 0 to about 2.0% by weight, more preferably from 0 to about 1.0% by weight, based on the total main monomer quantity. Mixtures of anionic emulsifiers can also be employed. However, preferred embodiments do not contain anionic emulsifier.

Along with emulsifiers, the vinyl ester/ethylene copolymer dispersions employed in accordance with the invention may comprise, as part of the stabilizer system, protective colloids, preferably polyvinyl alcohols and/or their modifications. Protective colloids, if present, are generally present only in comparatively low concentrations, as for example at up to about 3% by weight, based on the total amount of the main monomers used. The vinyl ester/ethylene copolymer dispersions employed herein will more preferably contain no protective colloids or only up to about 1% by weight of protective colloids, based on the total amount of the main co-monomers employed in the vinyl ester/ethylene copolymer.

Examples of suitable protective colloids include water-soluble or water-dispersible polymeric modified natural substances, such as cellulose ethers, examples being methyl, ethyl-, hydroxyethyl- or carboxymethylcellulose; water-soluble or water-dispersible polymeric synthetic substances, such as polyvinylpyrrolidone or polyvinyl alcohols or their copolymers (with or without residual acetyl content), and polyvinyl alcohol which is partially esterified or acetalized or etherified with saturated radicals, and also with different molecular weights.

The protective colloids can be used individually or in combination. In the case of combinations, the two or more colloids can each differ in their molecular weights or they can differ in their molecular weights and in their chemical composition, such as the degree of hydrolysis, for example.

In addition to the emulsifiers and, if appropriate, protective colloids that are used during the emulsion polymerization of the copolymers herein, it is also possible for the vinyl acetate/ethylene copolymer dispersions used herein to contain subsequently added watersoluble or water-dispersible polymers as hereinafter described. Additional emulsifiers may also be added to the dispersions post-polymerization.

### Copolymer Dispersion Preparation

The copolymer dispersions comprising the vinyl ester/ethylene copolymers described herein are prepared by emulsion polymerization procedures which result in the preparation of polymer dispersions in aqueous latex form. The emulsion polymerization is carried out in a tubular reactor comprising a closed loop section and a secondary line section. The closed loop section can be continuously charged with fresh monomers and water phase at substantially the same rate as the rate at which an overflow of reactor charge is discharged into the secondary line section, the reactor charge being continuously re-circulated within the closed loop section. The discharge rate and the circulation rate can be balanced to achieve low residual monomer content. Preferably the secondary line section has a volume of less than twice the volume of the closed loop section. Optionally, the secondary line section is coiled.

The secondary line section can for example be provided with at least two separate cooling jackets in serial arrangement. This allows optimization of the different stages of polymerization when the reactor charge passes through the secondary line section. This way, the first part of the secondary line section can be cooled to a lesser extent than a subsequent part of the secondary line section. The first part can for instance be cooled to a relatively high temperature of 70° C. or higher to maximize polymerization, whereas the subsequent part can be cooled to a greater extent, e.g., to 55° C. or less, so that the finished polymer emulsion is discharged to a storage tank at a reasonably low temperature.

Optionally, the secondary line section may have a diameter which is larger than the diameter of the line forming the closed loop section. With a larger diameter, the reactor charge will move along the secondary line section at a relatively slow speed. In another possible embodiment, the diameter of the secondary line section can be smaller than the diameter of the pipeline forming the closed loop section, which will increase the shear rate in the former.

The polymerization of the vinyl ester and ethylene can take place in aqueous suspension and preferably the raw materials are provided by separate feed streams. These streams introduce fresh monomer and an aqueous solution of stabilizer known as the water phase or, e.g., a pre-emulsion of monomer and water with stabilizer and an aqueous stabilizer solution in a separate small stream. At the start of the reaction, the reactor is filled with water phase made up in a solution tank. Other additions are also possible, particularly finished emulsion polymer (of the same or a different composition) from a previous run, optionally diluted to any concentration.

Agitation in the reactor is provided by virtue of an in-line circulation pump. Shortly after the feed streams start to flow, the monomers begin to react and heat is generated. The temperature is stabilized by cooling means, usually by controlled circulation of a cooling fluid (e.g. water) through a cooling jacket. The product flows to the cooling tank, where, if necessary, residual monomer can be further converted to polymer by adding more initiators to the copolymer dispersion. After cooling, the emulsion polymer is filtered to remove any oversize particles or gritty material in a strainer and transferred to the product storage tank.

The polymerization process is preferably carried out under pressure, for instance under a pressure of 10 to 150 bar.

In a typical polymerization procedure involving, for example, vinyl acetate/ethylene copolymer dispersions, the vinyl acetate, ethylene, and other co-monomers can be polymerized in an aqueous medium under pressures up to about 120 bar in the presence of one or more initiators, at least one emulsifying agent. The aqueous reaction mixture in the polymerization tubular reactor can be maintained by a suitable buffering agent at a pH of about 2 to about 7.

As noted, the polymerization of the ethylenically unsaturated monomers will generally take place in the presence of at least one initiator for the free-radical polymerization of these co-monomers. Suitable initiators for the free-radical polymerization, for initiating and continuing the polymerization during the preparation of the dispersions, include all known initiators which are capable of initiating a free-radical, aqueous polymerization in heterophase systems. These initiators may be peroxides, such as alkali metal and/or ammonium peroxodisulfates, or azo compounds, more particularly water-soluble azo compounds.

As polymerization initiators, it is also possible to use what are called redox initiators. Examples thereof are tert-butyl hydroperoxide and/or hydrogen peroxide in combination with reducing agents, such as with sulfur compounds, an example being the sodium salt of hydroxymethanesulfinic acid, Bruggolite® FF6 and FF7, Rongalit C, sodium sulfite, sodium disulfite, sodium thiosulfate, and acetone-bisulfite adduct, or with ascorbic acid, sodium erythobate, tartaric acid, or with reducing sugars.

The amount of the initiators or initiator combinations used in the process may vary within the usual limits for aqueous polymerizations in heterophase systems. In general the amount of initiator used will not exceed 5% by weight, based on the total amount of the co-monomers polymerized. The amount of initiators used, based on the total amount of the co-monomers polymerized, is preferably 0.05% to 2.0% by weight.

Preferably initiator is continuously added to the loop reactor. The addition may be made separately or together with other components, such as emulsifiers or monomer emulsions.

The molecular weight of the various copolymers in the copolymer dispersions herein can be adjusted by adding small amounts of one or more molecular weight regulator substances. These regulators, as they are known, are generally used in an amount of up to 2% by weight, based on the total co-monomers to be polymerized. As regulators, it is possible to use all of the substances known to the skilled artisan. Preference is given, for example, to organic thio compounds, silanes, allyl alcohols, and aldehydes.

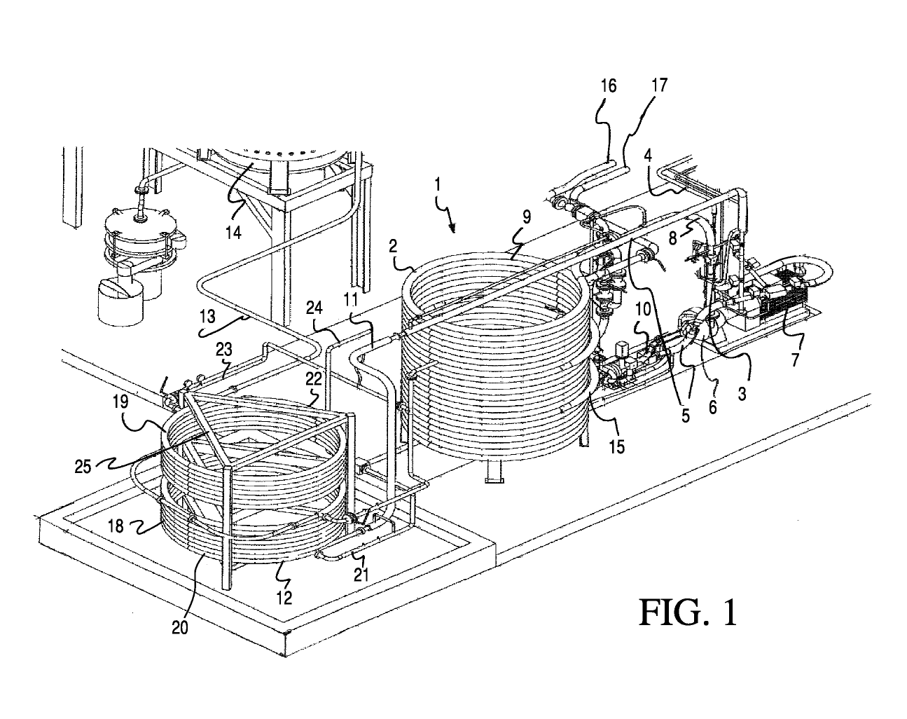

An example of a suitable continuous polymerization process is shown in FIG. 1, in which a tubular polymerization reactor 1 comprises a circulation loop 2 with a monomer inlet 3, a water phase inlet 4, and a discharge outlet 5 for finished copolymer product. A circulation pump 6 driven by a motor 7 serves as a driving means for circulating a reactor charge within the circulation loop 2, via line 8 to an upper section of the coiled part 9 of the circulation loop 2. In the coiled part 9, the reactor charge flows down and via line section 10 back to the circulation pump, 6 where the main part of the reactor charge is recirculated again, except for the part that is discharged via outlet 5. The discharged reactor charge has a residual monomer content of about 5% by weight. To obtain a continuous polymerization process, the outlet of the circulation loop 2 is such that the outflow rate equals the inflow rate of the raw materials and is substantially less than the flow rate of the recirculated material.

The reactor 1 further comprises a product take-off line 11 leading from the outlet 5 of circulation loop 2 to a coiled secondary line section 12. A discharge line 13 leads from the coiled section 12 to a cooling tank 14. The volume of the coiled section 12 is about equal to the volume of the circulation loop 2.

The coiled tube of the circulation loop 2 is covered by a hollow cooling jacket 15, through which cooling water flows. The cooling jacket 15 is connected to a cooling water inlet 16 and a cooling water outlet 17.

The coiled secondary line section 12 is similarly cooled and has a lower part 18 and a separately cooled upper part 19. To this end, the lower part 18 is provided with a cooling jacket 20, connected to a water inlet 21 and a water outlet (not shown). Similarly, the upper part 19 is provided with a separate cooling jacket 22, connected to another water outlet 23 and a water inlet 24. The lower part 18 of the secondary line section 12 is connected to the discharge outlet 5 of the circulation loop 2 and is cooled to a lesser extent than the subsequently cooled upper part 19 of the secondary line section 12. secondary line section 12 is hung in a frame 25.

### Copolymer Dispersion

The copolymer dispersions as prepared herein will generally have a viscosity which ranges from about 20 mPas to about 5000 mPas at 45-55% solids, more preferably from about 100 mPas to about 3000 mPas, most preferably 200-2000 mPas measured with a Brookfield viscometer at 25° C., 20 rpm, with appropriate spindle. Viscosity may be adjusted by the addition of thickeners and/or water to the copolymer dispersion. Suitable thickeners can include polyacrylates or polyurethanes, such as Borchigel L75® and Tafigel PUR 60®. Alternatively, the copolymer dispersion may be substantially free of thickeners.

Following polymerization, the solids content of the resulting aqueous copolymer dispersions can be adjusted to the level desired by the addition of water or by the removal of water by distillation. Generally, the desired level of polymeric solids content after polymerization is from about 40 weight percent to about 70 weight percent based on the total weight of the polymer dispersion, more preferably from about 45 weight percent to about 55 weight percent.

The aqueous copolymer dispersions used to form the binder coating or adhesive layer-forming compositions herein can be desirably low in Total Volatile Organic Compound (TVOC) content. A volatile organic compound is defined herein as a carbon containing compound that has a boiling point below 250° C. (according to the ISO 11890-2 method for polymer dispersions TVOC content determination) at atmospheric pressure. Compounds such as water and ammonia are excluded from VOCs.

The aqueous copolymer dispersions used herein will generally contain less than 3% TVOC by weight based on the total weight of the aqueous copolymer dispersion. Preferably the aqueous copolymer dispersion will contain less than 1% TVOC by weight based on the total weight of the aqueous copolymer dispersion; more preferably the aqueous copolymer dispersion will contain less than 0.5% TVOC by weight based on the total weight of the aqueous copolymer dispersion, most preferably below 0.3% TVOC according to ISO 11890-2, described hereinafter in the Test Methods section.

Where appropriate, the vinyl acetate/ethylene copolymer dispersions used herein can also optionally comprise a wide variety of conventional additives which are typically used in the formulation of binders and/or adhesives. Such optional additives may be present in the copolymer dispersion from the beginning of or during polymerization, may be added to the dispersion post-polymerization or, such as in the case of fillers, may be used in connection with preparation of the aqueous coating compositions from the copolymer dispersions as hereinafter described.

Typical conventional optional additives for the copolymer dispersions herein can include, for example, film-forming assistants, such as white spirit, Texanol®, TxiB®, butyl glycol, butyl diglycol, butyl dipropylene glycol, and butyl tripropylene glycol; wetting agents, such as AMP 90®, TegoWet.280®, Fluowet PE®; defoamers, such as mineral oil defoamers or silicone defoamers; UV protectants, such as Tinuvin 1130®; agents for adjusting the pH; preservatives; plasticizers, such as dimethyl phthalate, diisobutyl phthalate, diisobutyl adipate, Coasol B®, Plastilit 3060®, and Triazetin®; subsequently added stabilizing polymers, such as polyvinyl alcohol or additional cellulose ethers; and other additives and auxiliaries of the kind typical for the formulation of binders and adhesives. The amounts of these additives used in the VAE copolymer dispersions herein can vary within wide ranges and can be selected by the specialist in view to the desired area of application.

### Aqueous Binder Coating and Adhesive Compositions

The copolymer dispersions as hereinbefore described are combined with filler material and additional water to form aqueous carpet coating and/or adhesive compositions. Such coating/adhesive compositions are applied to the textile substrate(s) which form the carpet products herein. Upon drying, the applied aqueous coating and/or adhesive compositions then provide the coating and/or adhesive layers within the carpet products. The carpet product can comprise only one or more than one adhesive or coating layer.

In general, the carpet products herein will always contain a binder coating layer to secure the carpet fibers to a primary backing substrate. That binder coating layer can also serve as an adhesive layer if a scrim or other separate flexible secondary substrate is contacted with that binder coating layer prior to curing.

The carpet products herein can optionally also comprise a second separate layer which can be an adhesive layer to secure a secondary backing substrate to an already cured coated primary backing. In one embodiment, the carpet product can comprise both a binder coating layer and an adhesive layer which are formed from the same type of aqueous composition. Alternatively, the carpet products herein can comprise both a binder coating layer and an adhesive layer, wherein the two layers are formed from different aqueous compositions, with at least the binder coating layer, and preferably both layers, being formed from the type of vinyl ester/ethylene based aqueous compositions described herein.

The aqueous coating and/or adhesive compositions will also contain a particulate filler material selected from particulate inorganic compounds and particulate plastic materials. Thus, the filler employed can be essentially any filler suitable for use in carpet manufacture. Such fillers are widely commercially available.

Filler examples include inorganic, e g , mineral, fillers or pigments such as fly ash and ground glass and those known in the art, such as calcium carbonate, clay, kaolin, talc, barites, feldspar, titanium dioxide, calcium aluminum pigments, satin white, zinc oxide, barium sulphate, gypsum, silica, mica, and diatomaceous earth. Particulate plastic material such as synthetic polymer pigments, hollow polymer pigments and recycled carpet backing may also be employed, as can mixtures of any of the foregoing filler types. The preferred filler material is particulate calcium carbonate.

The particulate filler material can generally range in average particle size between about 200 nm and 1000 μm, more preferably between about 1 μm and 500 μm, most preferably 10 μm -300 μm. Preferred coating and/or adhesive compositions used to prepare carpet products in accordance with the present invention are loaded with filler to yield an aqueous coating and/or adhesive composition comprising from about 2.5 to about 50 weight percent, more preferably from about 10 to about 40 weight percent, and more preferably from about 20 to about 30 weight percent of dry copolymer and from about 50 to about 97.5 weight percent, preferably about 60 to about 90 weight percent, and most preferably from about 70 to 80 weight percent of filler based on total weight of solids in the aqueous composition, depending in part on the type and form of the carpet being constructed.

The aqueous carpet coating compositions herein can contain, in addition to the copolymer dispersions and filler materials hereinbefore described, a variety of additional conventional additives in order to modify the properties thereof. Among these additives may be included thickeners, rheology modifiers, dispersants, colorants, biocides, anti-foaming agents, etc. These optional additives are largely the same as those described above with respect to the copolymer dispersions used to form the coating compositions herein.

### Carpet Products

The aqueous coating compositions as described above are applied to the flexible substrate(s) which form the carpet products herein. Upon drying, the applied aqueous coating compositions then provide the coating, i.e., binder, and/or adhesive layers within the carpet products. The carpet products can comprise only one or more than one adhesive or binder coating layer.

The carpet products herein can optionally also comprise a second separate layer which can be an adhesive layer to secure a secondary backing substrate to an already cured coated primary backing. In one embodiment, the carpet product can comprise both a binder coating layer and an adhesive layer which are formed from the same type of aqueous composition. Alternatively, the carpet products herein can comprise both a binder coating layer and an adhesive layer, wherein the two layers are formed from different aqueous compositions, with at least the binder coating layer, and preferably both layers, being formed from the type of VAE-based aqueous compositions described herein.

Suitable flexible substrates for use with the present coating compositions can, for example, be selected from nonwovens, wovens, unidirectional weaves, knitted fabrics and pile fabrics. Thus the carpet products herein can be conventional tufted carpet, non-tufted carpet or needle-punched carpet. Such carpet products can be prepared by applying and drying the emulsion copolymer-containing aqueous compositions using equipment which is readily available in most carpet mills

Pile carpet products comprise a primary backing with pile yarns extending from the primary backing substrate to form pile tufts. Pile or tufted carpet can be prepared by a) tufting or needling yarn into a woven or non-woven backing substrate; b) applying the aqueous carpet coating composition as described herein to the rear of the backing such that the yam is embedded in the carpet coating composition; and c) drying the resultant carpet construction. In producing such tufted carpets, it is also desirable to apply a secondary backing to the primary backing either before or after drying of the carpet coating, depending upon the type of backing employed.

For tufted carpets, the primary backing substrate can be non-woven polypropylene, polyethylene or polyester or woven jute, polypropylene or poly amide (synthetic and natural). If a secondary backing is used, it is generally formed of woven or non-woven materials similar to those used as the primary backing and applied directly to the wet pre-coated primary backing prior to the drying step or applied with a separate adhesive to the dried precoated primary backing. Such a secondary backing provides dimensional stability to the carpet. The secondary backing also may be in the form of a preformed sheet polymer or copolymer. Suitable preformed sheet compositions include urethane polymers, polymers and copolymers of ethylene, propylene, isobutylene, and polyvinylbutyral.

The carpet products herein can also be non-tufted carpets wherein the fibers are embedded into a coating or binder composition which has been coated onto a woven or non-woven substrate. Non-tufted carpets also may be prepared by a) coating an aqueous composition such as hereinbefore described onto a substrate; b) embedding the carpet fibers in the substrate; and c) drying the resultant carpet construction. In forming a non-tufted carpet, the carpet coating can be thickened and applied to a scrim surface. The fibers then are directly embedded into the wet coating using conventional techniques and then dried. These non-tufted carpets also may be advantageously prepared utilizing a secondary backing that can provide additional dimensional stability.

In preparing the carpet products herein, the aqueous composition is applied in a manner such that it penetrates the fibers of the carpet yams to yield better adhesion, fiber bundle integrity, anti-fuzzing properties and suitable tuft-bind values. Suitable carpet performance properties can be achieved by applying an amount of the aqueous coating/binder composition ranging from about 100 g/m² to about 3000 g/m², more preferably from about 200 g/m² to about 2000 g/m², and most preferably from about 400 g/m² to about 1500 g/m² (dry basis).

### Carpet Product Characteristics

The carpet products herein, with the specific type of vinyl acetate/ethylene-based copolymer dispersions used in forming coating and/or adhesive layers, also have especially desirable, environmental characteristics. The copolymer dispersions used, by virtue of preferably containing no cross-linking groups which generate formaldehyde (e.g. no NMA or NMA-LF), and by virtue of their low TVOC content and TVOC emission, do not cause potentially problematic materials of this type to be emitted from the carpet products herein. Further, since the carpet products herein do not utilize SBR coatings or binders, the carpet product will also be substantially free of potentially toxic components such as 4-phenylcyclohexene (4-PCH), 4-vinylcyclohexene (4-VCH), styrene, and ethylbenzene. The carpet products herein, with the specific type of vinyl acetate/ethylene-based copolymers used in forming coating and/or adhesive layers, are also desirably resistant to degradation upon exposure to light having both visible and ultraviolet (UV) components.

### EXAMPLES

The aqueous coating compositions and carpet products having such compositions incorporated therein are more particularly described with reference to the following non-limiting Examples. The several test methods employed in connection with these Examples are described as follows:

### Test Methods

### Solids Content of Copolymer Dispersions or Coating Compositions

Solids content is measured by drying 1 to 2 grams of the aqueous dispersion or coating composition at 105° C. for 4 hours, and by then dividing the weight of dried polymer by the weight of dispersion or composition.

### Copolymer Glass Transition Temperature (Tg) Determination

The glass transition temperature, T_{g}. can be obtained by using a commercial differential scanning calorimeter Mettler DSC 820 at 10 K/min For evaluation, the second heating curve is used and the DIN mid point calculated.

### Copolymer Dispersion Volatile Organic Compound (VOC) Content

The total volatile organic compound content of the copolymer dispersion can be measured by using the ISO 11890-2 test method, which test method is incorporated herein by reference. This method determines the residual levels of Volatile Organic Components (VOC) by direct injection into a capillary gas chromatographic column The method follows the DIN ISO 11890-2 directive where TVOC is defined as the sum of all volatile organic components with a boiling point lower than tetradecane. This component has a boiling point of 253° C.

A Perkin Elmer Gas Chromatograph (Auto system X.L) fitted with PPC (Pneumatic Pressure control) is used with a Varian column V624, 60 meters, 320 μm internal diameter and 1.8 μm film thickness. The carrier gas is H₂. The detector is a FID.

For sample preparation, approximately 150 μl of sample is placed into a tared vial using a Gilson Micromann 250 positive displacement pipette. The auto sampler vial is weighed (g), and the result is noted as the divisor value. Approximately 1.5 ml of diluent solution (containing 100 ppm of methyl isobutyl ketone (MIBK) in deionized water as internal standard) is added to the auto sampler vial. The auto sampler vial is weighed (g), and the result is noted as the multiplier. The auto sampler vial is mixed thoroughly using a vortex mixer until the solution in the vial is completely homogenous. The sample vial is then placed on the sampling carousel of the Gas Chromatograph and measured according to ISO 11890-2. Each single VOC is calibrated initially. The result is the sum of all singles VOC values which is the Total Volatile Organic Component (TVOC) parameter in ppm.

### Surface Charge Measurements

The surface charge density was determined at 25° C. by means of stoichiometric polyelectrolyte titration with the stream-current detector (SCD) using the equipment Mütek PCD-04 and according to the method described in: J. P. Fischer, E. Milken, Progr. Colloid & Polymer Sci. 77, 1988, 180 and J. P. Fischer and R. Schafer, Kunstharz Nachrichten Hoechst 29, 1993, 48-51.

### Viscosity of Coating Compositions

Viscosity is determined at 25° C. using a Brookfield DV-I+ Viscometer, with spindle 2, speed 20 rpm.

Tuft Anchorage of Carpet Samples with Coating(s)

Three carpet samples having dimensions of 7×20 cm for each type of binder coating to be tested are prepared and stored for a minimum of 24 hours at 23° C. and 50% humidity prior to measurement. The strength of the tuft anchorage in such samples is then measured according to ISO 4919, which test method is incorporated herein by reference.

The testing machine used is made by Lloyd Instruments and is called LF Plus. The test program works with preloaded settings of 0.5 N force and a testing speed of 100 mm/min The carpet sample is clamped to a mounting which is a stainless steel tray of 10×10 cm. One loop of the sample is gripped with a compressor. The compressor is attached to the upper clamp of the testing device at an angle of 90° to the sample. The tufts are pulled upward until the tufts separate (break) from the carpet sample.

The maximum break force at tuft separation for each sample is measured. The breakpoint should be reached within 2 to 10 seconds. For each carpet, 20 tufts (3 samples tested/carpet sample with a given binder coating) are tested to give an average for the maximum break force. The break force is measured in Newtons (N).

Delamination of Carpet Samples with Coatings

Coated carpet samples with the dimension of 5×25 cm are prepared and the backing scrim are peeled from the carpet back. The delamination strength is measured according to the method ISO 11857.

The testing machine used is Lloyd Instruments LF Plus. The test program is set to a preload of 0.5 N force. The carpet samples are clamped to the machine and then 10 cm of the backing scrim is peeled from the carpet back at a speed of 100 mm/min while the peel strength is being measured.

For the calculation the average delamination strength the total length of 20 cm is separated into 5 equal parts. In each of these areas the maximum delamination strength is determined and averaged.

### Filler Tolerance Determination

Prior to the test all copolymer dispersions (binder) are diluted to 50% solid content. As filler a Calcium Carbonate distributed through Rheinkalk was used. The binder was mixed with the water upfront and the filler material was added slowly to the liquid to avoid formation of filler lumps during the mixing process. The formulation was stirred by means of an IKA EUROSTAR power control vise 6000 stirrer. The formulations made are judged visually In the present work 2 formulations were done, one at 75% filler/25% binder and the other one at 89% filler/11% binder (dry weight/dry weight).

### Example 1

### Preparation of VAE-Based Copolymer Dispersion

The aqueous copolymer dispersions of the examples were prepared with a continuous tubular reactor with a closed loop section and a secondary line section. The method was as follows: (1) A water phase containing water, partially hydrolyzed polyvinyl alcohol, a polyoxyethylene-polyoxypropylene block copolymer, sodium acetate, sodium metabisulfite and Mohr's salt is pumped into the loop section and the secondary line section of the reactor at a rate of 48 g /min (2) While the temperature is raised through hot water passing through a jacket system surrounding the process pipe, an oxidant emulsion containing water, polyvinyl alcohol, a polyoxyethylene-polyoxypropylene block copolymer, tert-butyl peroxide and tert-butyl peroxy-3,5,5-trimethylhexanoate is added through a second inlet pump into the loop section at a rate of 3.7 g/min. (3) Vinyl acetate is flushed at 54 g/min (4) Ethylene is pumped at 6.7 g/min (5) Soon after the oxidant feed and monomer feeds had started, the temperature increased, indicating an exothermic reaction. This reaction exotherm was controlled with cooling water passing through jackets surrounding the process pipe to maintain the reaction temperature at 60° C. The mean residence time of materials within the loop component was 10 minutes. The reactor was pressurized with a valve so that the system operated with a positive pressure of 65 bar. (5) When the process reached an equilibrium, as indicated in a constancy in conversion, in approximately 1.5 hours a 1 L specification sample was collected in a separate atmospheric tank to which was added a small amount of oxidizer and reducer to further reduce unreacted monomer. If desired, 10 more minutes is needed for each additional liter of sample.

The resulting VAE copolymer dispersion from Example 1 has the following characteristics:
Solids content: 52.1%
pH: 5.5
Viscosity: 970 mPas
Residual Vinylacetate: <1%
Tg: 14° C.

| pH | charge [μmol/g) |
|---|---|
| 3 | −2.7 |
| 7 | −9.8 |
| 10 | −14.6 |

### Example 2

### Preparation of VAE-Based Copolymer Dispersion

The same process as Example 1 was performed, with the only difference that 0.5% of a functional monomer glycidyl methacrylate (GMA) was added together with the vinyl acetate to the reactor.

The resulting VAE copolymer dispersion from Example 2 has the following characteristics:
Solids content: 51.6%
pH: 5.5
Viscosity: 1060mPas
Residual Vinylacetate: <1%
Tg: 14° C.

| pH | charge [μmol/g) |
|---|---|
| 3 | −1.7 |
| 7 | −11.4 |
| 10 | −12.7 |

### Comparative Example 1

### Preparation of VAE-Based Copolymer Dispersion

Into a pressure reactor with a volume of approximately 68.6 liters, equipped with an anchor stirrer, a heating jacket and dosage pumps, the following components are added: 25912 g deionized water, 1217 g of a partially hydrolyzed polyvinyl alcohol solution (29% in deionized water), 1059 g of a polyoxyethylene-polyoxypropylene block copolymer, 90 g of sodium acetate (anhydrous), 15 g of sodium metabisulfite and 0.1 g of Mohr's salt. This mixture is kept under stirring at 150 rpm. The ethylene valve is opened and the reactor is pressurized to 15 bar with ca. 1000 g of ethylene at ambient temperature. The reactor temperature is ramped up to 65° C. and 744 g of a 16% aqueous solution of sodium persulfate is added quickly. At 65° C. the rest of ethylene (ca.2882 g) is pressurized at 36 bar and a monomer addition comprising 31410 g of vinyl acetate and 177 g of glycidyl methacrylate is slow added during 240 minutes. 30 minutes before the monomer feed finishes, 663 g of a 6% aqueous solution of sodium persulfate is added. After the monomer feed finishes, the temperature is raised to 85° C. and kept for 60 minutes. The reactor is then cooled down to approximately 40° C. A final redox treatment can be made at this point by adding a small amount of oxidizer and reducer to further reduce unreacted monomer.

The resulting VAE copolymer dispersion from Comparative Example 1 has the following characteristics:
Solids content: 55.6%
pH: 4.3
Viscosity: 246 mPas
Residual Vinylacetate: <1%
Tg: 13° C.

| pH | charge [μmol/g) |
|---|---|
| 3 | −1.0 |
| 7 | −7.2 |
| 10 | −11.5 |

### Comparative Example 2

The same process as Comparative Example 1 was performed in the same reactor, with the only difference that the monomer addition was comprised of 31495 g of vinyl acetate, i.e., no functional monomer was added.

The resulting VAE copolymer dispersion from Example 2 has the following characteristics:
Solids content: 55.3%
pH: 4.4
Viscosity: 187mPas
Residual Vinylacetate: <1%
Tg: 13° C.

| pH | charge [μmol/g) |
|---|---|
| 3 | −0.4 |
| 7 | −2.6 |
| 10 | −7.5 |

### Comparative Example 3

The same process as Comparative Example 2 was performed in the same reactor, with the only difference that, in the beginning, together with the water phase, 576 g of a 30% aqueous solution of sodium vinylsulfonate (SVS) was added. This functional monomer is known for providing more stability to polymer dispersions when compounded with fillers, such as calcium carbonate, due to the ionic charges that are present on the particle surface.

The resulting VAE copolymer dispersion from Example 2 has the following characteristics:
Solids content: 54.9%
pH: 4.3
Viscosity: 740mPas
Residual Vinylacetate: <1%
Tg: 12° C.

| pH | charge [μmol/g) |
|---|---|
| 3 | −34.9 |
| 7 | −35.7 |
| 10 | −41.9 |

The results of the tuft anchorage and delamination tests conducted on carpet products produced from the copolymer dispersions of the above Examples and Comparative Examples are shown in Results Table 1, whereas the results of the filler tolerance tests are shown in Results Table 2.

RESULT TABLE 1

| | SVS | GMA | Delamination | Tuft Anchorage |
|---|---|---|---|---|
| Sample | [%] | [%] | [N/5 cm] | [N] |
| Example 1 | 0 | 0 | 28 | 26 |
| Example 2 | 0 | 0.5 | 27 | 24 |
| Comparative Example 1 | 0 | 0.5 | 33 | 17 |
| Comparative Example 2 | 0 | 0 | 26 | 18 |
| Comparative Example 3 | 0.5 | 0 | 34 | 15 |

RESULTS TABLE 2

| | Filler tolerance @ | Filler tolerance @ |
|---|---|---|
| Sample | 75% Filler | 89% Filler |
| Example 1 | passed/remained liquid | passed/remained liquid |
| Example 2 | passed/remained liquid | passed/remained liquid |
| Comparative Example 1 | passed/remained liquid | failed/became a paste |
| Comparative Example 2 | passed/remained liquid | failed/became a paste |
| Comparative Example 3 | passed/remained liquid | passed/remained liquid |

As shown in Results Table 2, the copolymer dispersions of Examples 1 and 2 prepared using the continuous tubular reactor with a closed loop section and a straight line section were able to tolerate high amounts (89%) of filler. Comparative Examples 1 and 2 from a batch process were not able to achieve this filler tolerance. It was only when the functional monomer, sodium vinylsulfonate in aqueous solution was added in Comparative Example 3 that high filler amounts could be tolerated. Surprisingly, the samples from continuous tubular reactor did not require the addition of such a functional monomer.

1. A carpet coating composition comprising:
an aqueous dispersion of a copolymer comprising polymerized co-monomers vinyl acetate and ethylene, where the dispersion is prepared by a continuous emulsion polymerization in a reactor comprising a closed loop section and a secondary line section.

2. A carpet coating composition comprising:
an aqueous dispersion of a copolymer comprising polymerized monomers vinyl acetate and ethylene, where the dispersion is prepared by a continuous emulsion polymerization in a polymerization reactor comprising a first section with a circulation loop with one or more inlets for raw material, a pump for circulating a reactor charge within the circulation loop, and a secondary line section not forming a closed loop connected to a discharge of the first section.

3. The composition of claim 2, wherein the volume of the secondary section is less than twice the volume of the circulation loop.

4. The composition of claim 2, wherein the mean residence time in the circulation loop is less than 12 minutes.

5. The composition of claim 1, wherein the aqueous dispersion further comprises an emulsifier.

6. The composition of claim 5, wherein the emulsifier is nonionic.

7. The composition of claim 1, wherein the aqueous dispersion further comprises a protective colloid.

8. The composition of claim 1, wherein the copolymer is substantially free of functional monomer.

9. The composition of claim 1, wherein the aqueous dispersion has a solids content ranging from 40 wt % to 60 wt % of the total composition.

10. The composition according to claim 9, wherein the solids material therein comprises 2.5 wt % to 50 wt % of dry copolymer solids and from 50 wt % to 97.5 wt % of filler solids and wherein the weight ratio of dry copolymer solids to dry filler solids ranges from 2:1 to 10:1.

11. The composition according to claim 1, wherein said copolymer in the aqueous dispersion is substantially free of cross-linkable co-monomer moieties.

12. The composition according to claim 1, wherein the copolymer dispersion has a particle size, dw, from 200 to 500 nm as determined by Laser Aerosol Spectroscopy.

13. A carpet comprising:
a carpet backing or substrate,
carpet fibers, and
a carpet coating composition which comprises an aqueous dispersion of a copolymer comprising polymerized monomers vinyl acetate and ethylene, where the dispersion is prepared by a continuous emulsion polymerization in a continuous polymerization reactor comprising a closed loop section and a secondary line section.

14. A carpet product comprising at least one flexible substrate and at least one coating and/or adhesive layer associated with said at least one flexible substrate, said coating and/or adhesive layer being formed from an aqueous composition comprising:
A) an aqueous dispersion of a copolymer comprising polymerized co-monomers vinyl acetate and ethylene, where the dispersion is prepared by a continuous emulsion polymerization in a reactor comprising a closed loop section and a secondary line section; and
B) at least one particulate filler material selected from particulate inorganic compounds and particulate plastic material.
